(19) United States
(12) Patent Application Publication
(10) Pub. No.: US 2012/0154495 A1
(43) Pub. Date: Jun. 21, 2012

(54) Oxygen Inhibition for Print-Head Reliability

(76) Inventor: Paul Edwards, Saline, MI (US)

(21) Appl. No.: 12/968,748

(22) Filed: Dec. 15, 2010

(51) Int. Cl. B41J 2/01

(52) U.S. Cl. 347/102

(57) ABSTRACT

Systems and methods of applying a gaseous inhibitor into a printing region to hinder the curing process of ink on the print heads caused by the presence of stray light in the printing environment.

### BACKGROUND OF THE INVENTION

1. Technical Field

The invention relates to the field of inkjet printing. More specifically the invention relates to systems and methods of applying a gaseous inhibitor into a printing region to hinder the curing process of ink on the print heads caused by the presence of stray light in the printing environment.

2. Description of the Related Art

Using electromagnetic radiation to cure liquid chemical formulations has been an established practice for many years. Electromagnetic radiation curing involve a liquid chemical formulation comprising photoinitiators, monomers and oligomers, and possibly pigments and other additives and exposing the formulation to electromagnetic radiation, thereby converting the liquid chemical formulation into a solid state.

In printing applications, radiation-curable ink is jetted from a print head onto a substrate to form a portion of an image. In some applications, the print head scans back and forth across a width of the substrate, while the substrate steps forward for progressive scan passes. In some other applications, one or more blocks of fixed print head are used to build an image.

In each of these printing settings, curing ink involves directing photons, typically with wavelengths in or near the ultraviolet spectrum, onto an ink deposit. The photons interact with photoinitiators present within the ink, creating free radicals. The created free radicals initiate and propagate polymerization (cure) of the monomers and oligomers within the ink. This chain reaction results in the ink curing to a polymer solid.

However, the use of curable inks has created negative side effects. In particular, standard ink curing designs have issues with the print heads being exposed to stray light and with ink hardening onto the print heads due to the exposure. Stray light enters the printing environment in a variety of ways. For example, environmental light enters even the smallest openings and reflects throughout the system. Additionally, printing systems are oftentimes opened to environmental light to access printer components. Furthermore, printing system sometimes produce their own light by way of scanner functions or curing lamps.

Exposure to any stray light encourages ink to harden onto print heads. The harden ink subsequently deflects the spray from the print head and causing poor print quality. Indeed, even a very small deflection in ink spray can cause ruinous results.

In all types of printers which use light-curing (i.e. wideformat, super wide format, single pass, etc.), similar methodologies have been applied to limit the impact of stray or ambient light. Some workaround include the use of physical shutters and baffles to deflect the light coming from the lamps. However, no matter how much shielding is used, stray light still enters the printer. Another attempted solution involves configuring a curing lamp at such an angle that the light cannot deflect back at the print-heads. However, this technique detracts from the lamp's effectiveness in curing. Another attempted approach involved configuring a shield around the print zone which stops ambient light, especially UV, from entering the printer and reaching the heads. However, as explained above, stray light still enters the printer.

A number of other factors exacerbate the problems associated with stray light. Firstly, there are issues with inks curing on heads where the substrates being printed are very reflective, such as metallic finish substrates and even glossy white substrates. In these cases the amount of reflected light is much higher than usual. Secondly, with the increase in cure speed of the printers, both the ink sensitivity to UV light and the amount of light applied have increased substantially, thereby causing increased risk of ink curing on the heads. Thirdly, there are instances in printer design, where there is insufficient room to effectively shield the heads from stray light from the source.

Moreover, light emitting diodes (LEDs) are now predominately used for ink curing. The LEDS used operate at wavelengths in the upper band of the visible spectrum and into the ultraviolet spectrum and the ink is designed to be cured at these wavelengths. Accordingly, environmental light is particularly troublesome since environmental light contains a lot of energy in that band.

Yet another complication to the problem of stray light arises from the practice of using gaseous nitrogen in a print system to supplant oxygen. The presence of oxygen at the ink surface inhibits the curing reaction from occurring within the ink. This is often referred to as oxygen inhibition. Accordingly, the practice of supplanting oxygen in a curing region increases the efficiency of the cure process. However, nitrogen curing results in escaped nitrogen exposed to the print region, thereby exacerbating the problem of ink becoming cured to the printer heads.

### SUMMARY OF THE INVENTION

In view of the foregoing the invention provides systems and methods of applying a gaseous inhibitor into a printing region to hinder the curing process of ink on the print heads caused by the presence of stray light in the printing environment.

Some embodiments of the invention involve singe- and multi-layer single-pass printing systems involving oxygen applicators for supplying a blanket of oxygen to a substrate entering a printing region. Likewise, some embodiments of the invention involve a method of oxygen inhibition in single- and multi-layer printing systems.

Some embodiments of the invention involve a multi-pass scanning printing system having a carriage with a plurality of oxygen applicators, a plurality curing lamps, a plurality of nitrogen applicator, and a hardware controller or selectively activating and deactivating the various applicators as the carriage sweeps back and forth across the substrate.

Some embodiments of the invention involve a method for selectively activating and deactivating various nitrogen and oxygen applicators as a print carriage sweeps back and forth across the substrate in a multi-pass scanning printing system.

### BRIEF DESCRIPTION OF THE DRAWINGS

FIG. 1A illustrates a prior art single-pass printing system involving the application of nitrogen in a process of ultraviolet (UV) curing

FIG. 1B illustrates a prior art single-pass, multi-layer inkjet printing apparatus configured to deposit two layers of ink on a substrate;

FIG. 2A illustrates a single-pass printing system involving oxygen inhibition according to some embodiments of the invention;

FIG. 2B illustrates a single-pass, multi-layer inkjet printing apparatus with multiple oxygen inhibition regions according to some embodiments of the invention;

FIG. 2C illustrates a method of oxygen inhibition in a multi-layer printing system according to some embodiments of the invention;

FIG. 3A illustrates a prior art multi-pass scanning printing system configured to deposit ink onto a substrate;

FIG. 3B illustrates a multi-pass scanning printing system with a plurality of oxygen applicators according to some embodiments of the invention; and

FIG. 4 illustrates a workflow for the multi-pass scanning print system described in FIG. 3B according to some embodiments of the invention;

### DETAILED DESCRIPTION OF THE INVENTION

The invention solves the problem of inks curing on print-heads and nozzles in printing systems due to the effects of stray light from the a curing lamp or from the outside environment by introducing curing inhibition zones around the print heads where curing effectively becomes much more difficult to occur. In the presently preferred embodiments of the invention, the inhibition zones comprise an application of oxygen to a print head region, thereby reducing the ability for ink to cure on the heads due to oxygen's inhibition effect on the free radical cure process.

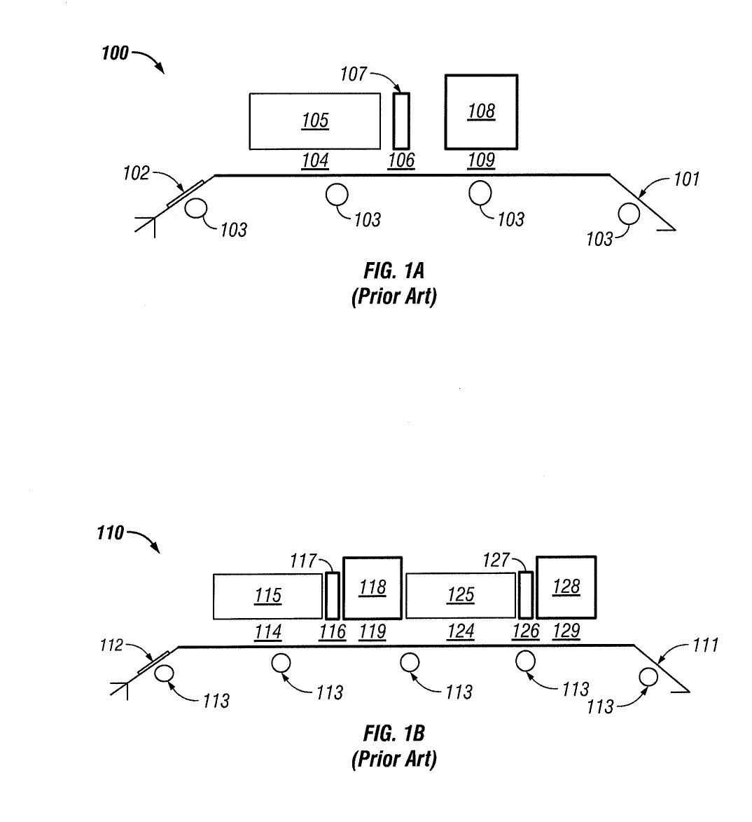

FIG. 1A illustrates a prior art single-pass printing system 100 involving the application of nitrogen in a process of ultraviolet (UV) curing. According to FIG. 1A, a transport surface 101 is directed over a series of rollers 103 and is configured to move a substrate 102 through the printing system 100.

The substrate 102 is first transported through a printing region 104 beneath a block of print heads 105 configured for applying ink to the substrate 102. According to FIG. 1, the block of print heads 105 applies UV curable ink. Once the substrate 102 is exposed to the application of ink, it is subsequently passed through an inerting zone 106 comprising a region exposed to a blanket of nitorgen applied via a nitrogen applicator 107. Environmental air contains about 20% Oxygen and 78% Nitrogen. Accordingly, the blanket of nitrogen replaces environmental air a less reactive nitrogen gas composition—usually 95% up to 99.9% pure nitrogen. Oxygen is a natural inhibitor of free radical cure and the removal of the Oxygen significantly increases the rate of cure at the surface of the ink.

Finally, the printed and inerted substrate is transported into a curing region 109 where the ink is exposed to light from a curing lamp 108, thereby curing the ink.

Although inerting zone 106 is located after the printing region 104 in the transport process, a portion of the nitrogen disperses to the printing region 104. As explained above, stray light enters the printing environment in a variety of ways and exposure to any stray light encourages ink to harden onto print heads. Therefore, the presence of nitrogen in the printing region 104 significantly increases the rate of cure of ink on the print heads.

The problem associated with the presence of nitrogen in a printing region is exacerbated in multilayer printing system. There are many instances where multilayer printing is advantageous. For example, two-sided images are printed on a transparent substrate using an intermediate white layer. FIG. 1B illustrates a prior art single-pass, multi-layer inkjet printing apparatus 110 configured to deposit two layers of ink on a substrate 112.

According to FIG. 1B, a transport surface 111 is directed over a series of rollers 113 and is configured to move a substrate 112 through the printing system 110.

The substrate 112 is transported through a first printing region 114 beneath a first block of print heads 115 configured for applying ink to the substrate 112. After the substrate 112 is exposed to the application of ink, it is subsequently passed through an inerting zone 116 comprising a region exposed to a blanket of nitorgen applied via a nitrogen applicator 117. Next, the printed and inerted substrate 112 is transported into a first curing region 119 where the ink is exposed to light from a first curing lamp 118, thereby curing a first layer of ink.

The substrate 112 is then transported through a second printing region 124 beneath a first block of print heads 125 configured for applying ink to the substrate 112. After the substrate 112 is exposed to a second application of ink, it is subsequently passed through a second inerting zone 126 comprising a region exposed to a blanket of nitorgen applied via a second nitrogen applicator 127. Finally, the substrate 112 is transported into a second curing region 129 where the ink is exposed to light from a second curing lamp 128, thereby curing a second layer of ink.

As previously mentioned, the problem associated with the presence of nitrogen in a printing region is exacerbated a multilayer printing system like the one illustrated in FIG. 1B. This is due to the introduction of even more nitrogen into the second printing region 124 in addition to dispersed nitrogen. As the substrate 112 is transported through the stations, nitrogen gas from the inerting zones is “pulled” along with the substrate. Therefore, the substrate 112 delivers nitrogen gas to the second printing region 124. This excess nitrogen gas significantly increases the rate of cure of ink on the print heads due to stray light.

The presently preferred embodiments of the invention address the problems associated with the prior art solutions through oxygen inhibition in the printing regions.

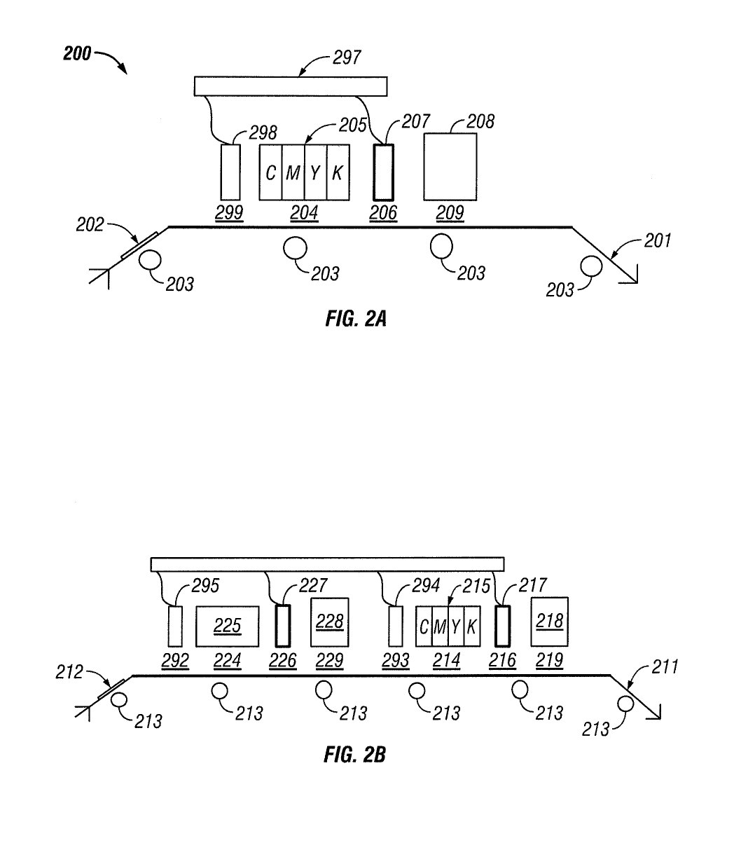

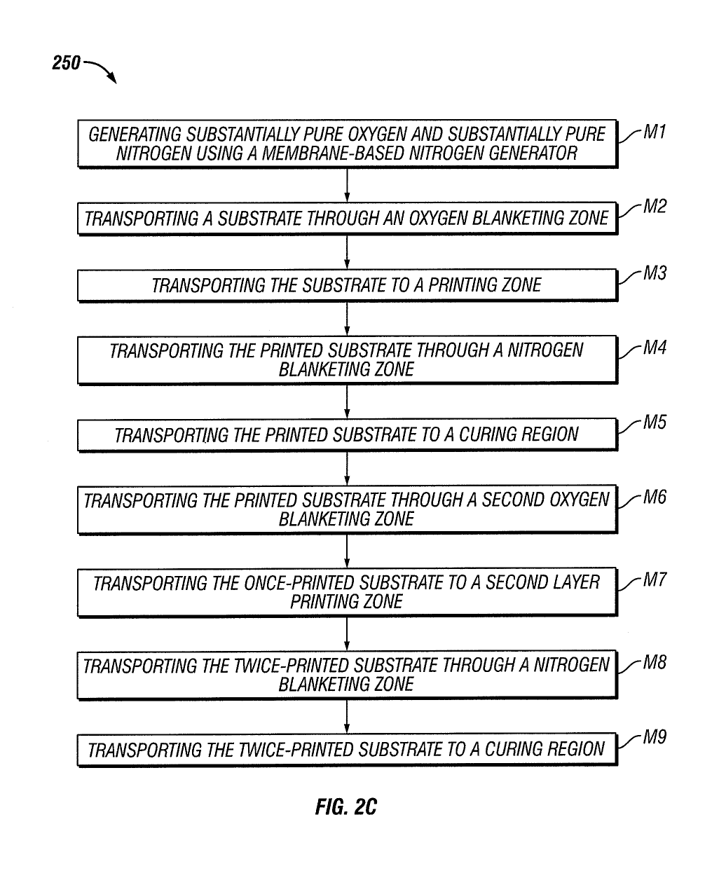

FIG. 2A illustrates a single-pass printing system 200 involving oxygen inhibition according to some embodiments of the invention. According to FIG. 2A, a transport surface 201 is directed over a series of rollers 203 and is configured to move a substrate 202 through the printing system 200.

According to FIG. 2A, the substrate 202 is first transported through an oxygen inhibition region 299 in which a blanket of oxygen is deposited via an oxygen applicator 298. This technique of Oxygen inhibition protects the printheads from having ink cure on them due to stray or ambient light due to the fact that the Oxygen rich feed is applied just before the heads and the motion of a substrate helps to create a blanket across the heads. In other words, the blanket of Oxygen rich air is dragged along with the substrate and remains present near the print-heads while the printer is in operation.

The transport surface 201 moves the substrate 202 into the printing region 204 beneath a block of print heads 205 configured for applying ink to the substrate 202.

As shown in FIG. 2A, the printing block 205 includes printheads defining the CMYK color model. However, it will be readily apparent to those with ordinary skill in the art having the benefit of the disclosure that other color models, now known or later developed, are equally applicable to accomplish the invention, as disclosed broadly herein.

In the presently preferred embodiments of the invention, the block of print heads 205 applies UV curable ink which is subsequently cured in a curing region 209 by a UV curing lamp 208. However, oxygen blanket must be deflected before it reaches the cure station 209, otherwise the oxygen will inhibit cure of the print, as explained above. Therefore, once the substrate 202 is exposed to the application of ink, it is subsequently passed through an inerting zone 206 comprising an inerting region 206 exposed to a blanket of nitorgen applied via a nitrogen applicator 207. In some other embodiments, the evacuation of oxygen is accomplished using baffles.

Finally, the printed and inerted substrate is transported into a curing region 209 where the ink is exposed to light from a curing lamp 208, thereby curing the ink.

In some embodiments of the invention, the nitrogen gas supplied to the nitrogen applicator 207 and the oxygen supplied to the oxygen applicator 298 are delivered via separate nitrogen and air sources.

In the presently preferred embodiments of the invention, a membrane-based nitrogen generator 297 is used to supply the nitrogen gas and the oxygen gas. Indeed, eliminating separate nitrogen or oxygen tanks obviates the need for consumable nitrogen or oxygen tanks that constantly require replacement and that can be expensive. Furthermore, the elimination of tanks further reduces the footprint of the system.

In some embodiments of the invention, an adsorption gas separation process is used to generate nitrogen. In some other embodiments, a gas separation membrane is used to generate nitrogen. According to the embodiments in which a membrane is used, a compressed air source delivers air that is first cleaned to remove oil vapor or water vapor. The clean, compressed air is then driven through a series of membranes to separate oxygen out of the air, resulting in a gas having higher levels of nitrogen.

In some embodiments of the invention, the purity of the oxygen stream into the applicator 298 ranges between 40% and 60%. In some other embodiments of the invention, the purity of the oxygen stream into the applicator 298 ranges between 60% and 80%.

In the presently preferred embodiments of the invention, the purity of the oxygen stream into the applicator 298 is greater than 80%. In some embodiments of the invention, a static elimination device is strategically positioned in the system 200 to avoid creation of ignition points, such as sparks in the oxygen rich atmosphere.

Also, in the presently-preferred embodiments of the invention, the curing lamp 208 comprises light-emitting diodes (LEDs). However, it will be readily apparent to those with ordinary skill in the art having the benefit of the disclosure that other types of lighting technology, such as incandescent lamps and fluorescent lamps, are equally applicable.

The problems associated with the presence of nitrogen in a printing region in a multilayer printing system explain in relation to FIG. 1B are eliminated in a printing system 220 according to FIG. 2B.

FIG. 2B illustrates a single-pass, multi-layer inkjet printing apparatus 210 with multiple oxygen inhibition regions according to some embodiments of the invention.

According to FIG. 2B, a transport surface 211 is directed over a series of rollers 213 and is configured to move a substrate 212 through the printing system 210.

The substrate is first applied with a blanket of oxygen from an oxygen applicator 295 when the substrate is passed into a first oxygen inhibition region 292. The substrate 212 is then transported through a first printing region 224 beneath a first block of print heads 225 configured for applying ink to the substrate 212. In some cases for printing two-sided images on a transparent substrate, the first block of print heads 225 are configured to apply white, or otherwise opaque, ink onto the transparent substrate.

After the substrate 212 is exposed to the application of ink, it is subsequently passed through a first inerting zone 226 comprising a region exposed to a blanket of nitrogen applied via a nitrogen applicator 227. Next, the printed and inerted substrate 212 is transported into a first curing region 229 where the ink is exposed to light from a first curing lamp 228, thereby curing a first layer of ink.

The substrate 212 is applied with a second blanket of oxygen from a second oxygen applicator 294 when the substrate is passed into a first oxygen inhibition region 293. The substrate 212 is then transported through a second printing region 214 beneath a second block of print heads 215 configured for applying ink to the substrate 112. In the case of printing two-sided images, the second block of print heads 215 is preferably the color print heads.

After the substrate 212 is exposed to a second application of ink, it is subsequently passed through a second inerting zone 216 comprising a region exposed to a blanket of nitrogen applied via a second nitrogen applicator 217. Finally, the substrate 112 is transported into a second curing region 219 where the ink is exposed to light from a second curing lamp 218, thereby curing a second layer of ink.

FIG. 2C illustrates a method of oxygen inhibition 250 in a multi-layer printing system according to some embodiments of the invention. In the presently preferred embodiments of the invention, the method 250 begins with generating substantially pure oxygen and substantially pure nitrogen at step M1 using a membrane-based nitrogen generator.

The method 250 continues with transporting a substrate through an oxygen blanketing zone at step M2. The substrate is then transported to a printing zone at step M3 wherein ink is applied to the substrate in an oxygen rich atmosphere. Next, the substrate is transported through a nitrogen blanketing zone at step M4 wherein the oxygen and other gases are supplanted by a blanket of nitrogen. The substrate is then transported to a curing region at step M5 wherein the ink is illuminated with ultraviolet light in a nitrogen rich atmosphere.

The method 250 continues with transporting the printed substrate through a second oxygen blanketing zone at step M6. The printed substrate is then transported to a second layer printing zone at step M7 wherein a second layer of ink is applied to the printed substrate in an oxygen rich atmosphere. Next, the twice-printed substrate is transported through a nitrogen blanketing zone at step M8 wherein the oxygen and other gases are supplanted by a blanket of nitrogen. The twice-printed substrate is then transported to a curing region at step M9 wherein the ink is illuminated with ultraviolet light in a nitrogen rich atmosphere.

The benefits of using oxygen inhibition in relation to the single-pass printing systems described above are also relevant to multi-pass, or scanning, printing systems.

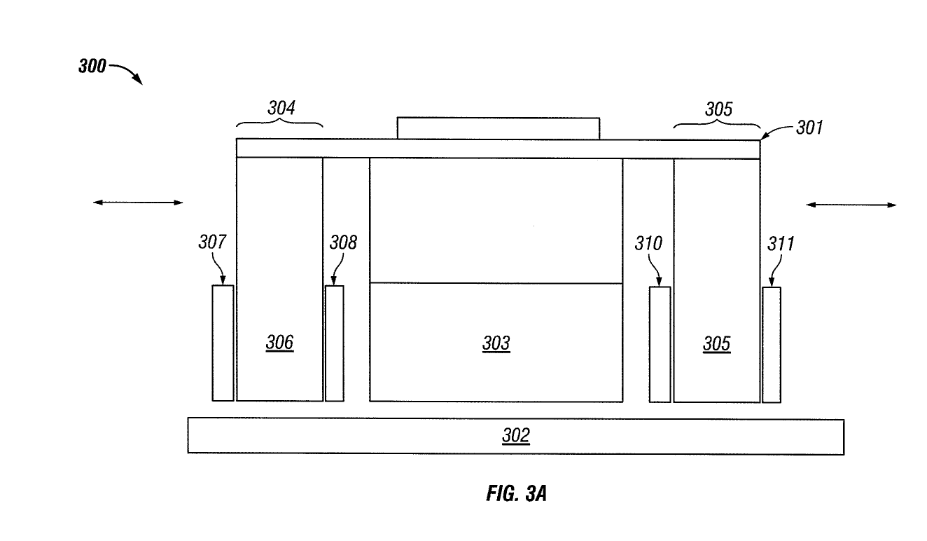

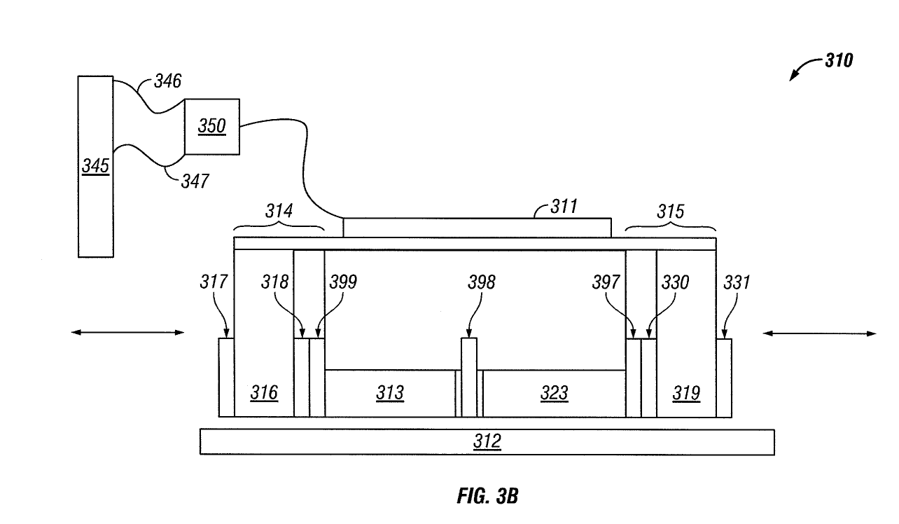

FIG. 3A illustrates a prior art multi-pass scanning printing system 300 configured to deposit ink onto a substrate 302. According to FIG. 3A, a print carriage 301 moves back and forth across a substrate 302 (as indicated by the arrows) as the substrate 302 steps forward under the print carriage 301 (into the page). The carriage 301 includes a printing block 303 with print heads configured for applying liquid ink to the substrate 302. The carriage 301 also includes two curing stations 304, 305 positioned on either side of the printing block 303. Curing station 304 comprises a curing lamp 306 and two nitrogen applicators 307, 308. Likewise, curing station 305 comprises a curing lamp 309 and two nitrogen applicators 310, 311.

The printing system 300 of FIG. 3A is a multi-pass printing system characterized by the fact that the printing block 303 applies ink to the same spot on the substrate at least two times. Accordingly, as the print carriage 301 moves back and forth, the printing block 303 applies ink to the substrate 302 and the curing lamp (306 or 309) of the trailing curing station (304 or 305) partially cures the deposited ink. In the return traversal, the curing lamp (306 or 309) of the leading curing station (304 or 305) fully cures the previously partially-cured ink before the printing block 303 applies another deposit of ink.

The nitrogen applicators (307, 308, 310, and 311) are somewhat directional in that the gas they emit is blanketed in a trailing fashion. Therefore, the leading curing station (304 or 305) deposits nitrogen gas directly to an area where the print heads of the printing block 303 will be moments after its deposit, thereby encouraging the curing of ink to the print heads.

Therefore, some embodiments of the invention involve oxygen applicators in a multi-pass, scanning printing system, thereby inhibiting the curing of ink on the print heads.

FIG. 3B illustrates a multi-pass scanning printing system 310 with a plurality of oxygen applicators 399, 398, 397 according to some embodiments of the invention.

According to FIG. 3B, a print carriage 311 moves back and forth across a substrate 312 (as indicated by the arrows) as the substrate 312 steps forward under the print carriage 311 (into the page). The carriage 311 includes a plurality of printing blocks 313, 323 with print heads configured for applying liquid ink to the substrate 312.

The printing system 310 of FIG. 3B is a multi-pass printing system characterized by the fact that the printing blocks 313, 323 apply ink to the same spot on the substrate 312 at least two times.

The carriage 311 also includes two curing stations 314, 315 positioned on either side of the carriage 311. Curing station 314 comprises a curing lamp 316, two nitrogen applicators 317, 318, and an oxygen applicator 399. Likewise, curing station 315 comprises a curing lamp 319, two nitrogen applicators 330, 331, and another oxygen applicator 397. A third oxygen applicator 398 is positioned between the two printing blocks 313, 323.

As the print carriage 311 moves back and forth, the printing blocks 313, 323 applies ink to the substrate 312 and the curing lamp (316 or 319) of the trailing curing station (314 or 315) partially cures the deposited ink. In the return traversal, the curing lamp (316 or 319) of the leading curing station (314 or 315) fully cures the previously partially-cured ink before the printing block 303 applies another deposit of ink.

The nitrogen applicators (317, 318, 330, and 331) and the oxygen applicators (399, 398, and 397) are somewhat directional in that the gas they emit is blanketed in a trailing fashion. Therefore, the leading curing station (314 or 315) deposits nitrogen gas directly to an area where the print heads of the printing block 303 will be moments after its deposit.

The printing system 310 of FIG. 3B also includes a controller 350 configured to selectively activate and deactivate the nitrogen applicators 317, 318, 330, and 331 and the oxygen applicators 399, 398, and 397 in such a way as to apply a steady blanket of oxygen around printing blocks 313, 323, thereby hindering ink curing on the print heads, while simultaneously applying a blanket of nitrogen in the curing regions, thereby ensuring a good cure.

In the presently preferred embodiment of the invention, the controller 350 is coupled with a membrane-based nitrogen generator 345 used to supply the nitrogen gas via supply tube 346 and the oxygen gas via supply tube 347. Also in the presently preferred embodiments, the controller 350 comprises a processor (not shown) configured to selectively open and close a plurality of valves (not shown) for selectively allowing nitrogen flow from the nitrogen supply tube 346 to the nitrogen applicators 317, 318, 330, and 331 and for selectively allowing oxygen flow from the oxygen supply tube 347 to the oxygen applicators 399, 398, and 397. The selective allowance of nitrogen gas and oxygen gas is described in detail below.

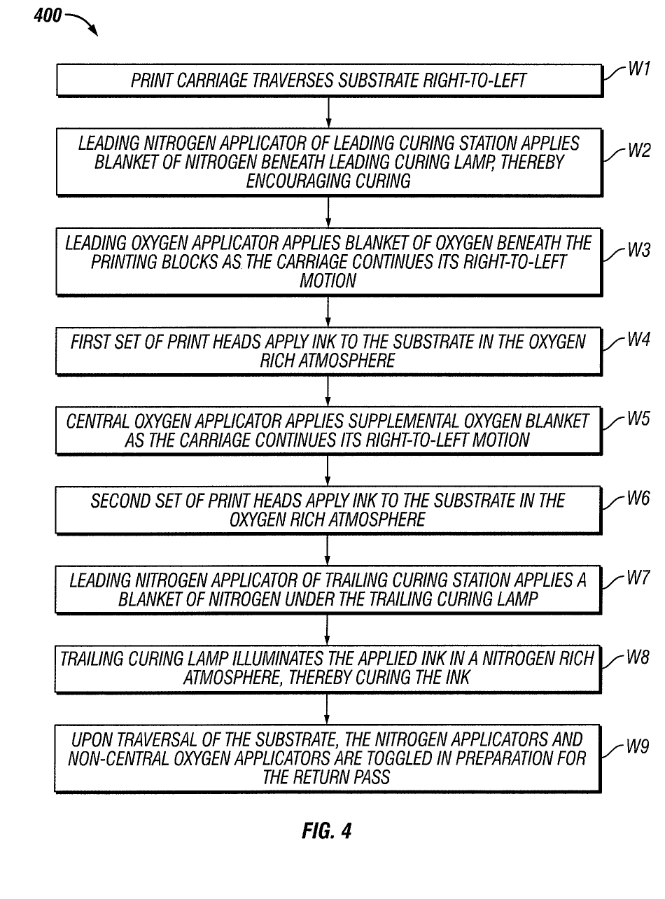

FIG. 4 illustrates a workflow 400 for the multi-pass scanning print system described in FIG. 3B according to some embodiments of the invention. Accordingly, the same reference numerals are used in FIG. 4 as in FIG. 3B to describe the workflow 400.

The workflow 400 describes a multi-pass printing process that is mid-operational—in that the printing blocks 313, 323 have already applied at least a first application of ink to the substrate 312. For the purpose of FIG. 4, suppose that the print carriage 311 starts on the right hand side of the substrate 312 and moves toward the left hand side at step W1.

At step W2, the carriage 311 moves right-to-left, nitrogen applicator 317 is active such that nitrogen passes beneath curing lamp 316, thereby encouraging curing of ink previously printed and partially cured in a previous pass.

Next, at step W3, the leading oxygen applicator 399 is activate such that a blanket of oxygen supplants the nitrogen and passes beneath the printing block 313 as the carriage 311 continues its right-to-left motion. Accordingly, the blanket of oxygen protects the print heads of printing block 313, as the print heads apply ink to the substrate 312 in the oxygen rich atmosphere at step W4.

In some embodiments of the invention, the printing blocks 313, 323 have a large profile such that the blanket of oxygen diffuses during the time the printing blocks move over a point on the substrate 312. In these embodiments, a central oxygen applicator 398 is configured between the printing blocks 313, 323. Preferably, the central oxygen applicator 398 is active at all time during the workflow 400. Accordingly, the central oxygen applicator 398 applies supplemental oxygen to the printing area at step W5 after the leading printing block 313 passes over the area. Next, at step W6, the trailing printing block 323 applies ink to the substrate 312 in the oxygen rich atmosphere.

After the application of ink from printing blocks 313 and 323, the workflow 400 continues as the trailing curing station 315 passes over the area of the substrate 312 recently printed on. At step W7, the leading oxygen application 397 remains inactive and the leading nitrogen applicator 330 is activate, thereby providing a blanket of nitrogen under the curing lamp 319. At step W8, the curing lamp 319 illuminates the applied ink in a nitrogen rich atmosphere, thereby curing the ink.

Once the carriage 311 reaches its left-most point in its traversal of the substrate 312, the nitrogen applicators 317, 318, 330, 331 and oxygen applicators 399 and 397 are toggled at step W9 in preparation for the return pass. In some embodiments of the invention, the applicators are switched from active to inactive using a central valve control. However, it will be apparent to those having ordinary skill in the art that a variety of control mechanisms are equally applicable.

More specifically, at step W9, when the carriage 311 travels left-to-right, the nitrogen applicator 331 is switched on and nitrogen applicator 317 is switched off; the nitrogen applicator 330 is switched off to keep nitrogen away from print heads; the oxygen applicator 397 is switched on to apply a blanket of oxygen for the printing blocks 323, 313; the nitrogen applicator 318 is turned on to provide a nitrogen blanket under the curing lamp 316; and the oxygen applicator 399 is switched off.

In some embodiments of the invention the curing lamps 316 and 319 are standard Ultraviolet lamps. According to these embodiments, both curing lamps 316 and 319 remain active during the workflow 400. In some other embodiments, the curing lamps 316 and 319 are Light Emitting Diode (LED) lamps. According to these embodiments, the LED curing lamps 316 and 319 are turned on and off when not positioned over uncured ink, thereby reducing system light.

According to the workflow 400 of FIG. 4, a blanket of oxygen remains present in the printing regions while a blanket of nitrogen remains present in the curing regions, thereby optimizing the printing process and protecting the print heads.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A printing system comprising:
a nitrogen generator configured for separating environmental atmosphere into a substantially-pure oxygen component and a substantially-pure nitrogen component;
a plurality of in-line printing stations comprising:
an oxygen application device operatively coupled in fluid communication with said nitrogen generator, said oxygen application device configured for emitting a blanket of substantially-pure oxygen;
a printing block positioned later in-line than said oxygen application device, said printing block containing a plurality of print heads configured for applying liquid, curable ink to a substrate;
a nitrogen application device positioned later in-line than said printing block, said nitrogen application device operatively coupled in fluid communication with said nitrogen generator, said nitrogen application device configured for emitting a blanket of substantially-pure nitrogen; and
a curing lamp positioned later in-line than said nitrogen application device, said curing lamp configured for illuminating and curing an application of ink on a substrate;
a transport surface configured for supporting a substrate and for transporting said substrate through said plurality of in-line print stations.

2. The printing system according to claim 1, wherein said plurality of in-line printing stations further comprises:
at least one additional oxygen application device operatively coupled in fluid communication with said nitrogen generator, said at least one additional oxygen application device configured for emitting a blanket of substantially-pure oxygen onto a once-printed substrate;
at least one additional printing block positioned later in-line than said at least one additional oxygen application device, said at least one additional printing block containing an additional plurality of print heads configured for applying liquid, curable ink in an additional application to a substrate;
at least one additional nitrogen application device positioned later in-line than said at least one additional printing block, said at least one additional nitrogen application device operatively coupled in fluid communication with said nitrogen generator, said at least one additional nitrogen application device configured for emitting a blanket of substantially-pure nitrogen; and
at least one additional curing lamp positioned later in-line than said at least one additional nitrogen application device, said at least one additional curing lamp configured for illuminating and curing an additional application of ink on a substrate.

3. A method of printing comprising:
transporting a substrate through a series of in-line printing stations comprising a first oxygen inhibition station, a first printing station, a first nitrogen inerting station, and a first curing station;
blanketing said substrate with an oxygen blanket in said first oxygen inhibition station;
applying curable ink to said blanketed substrate in said first printing station, resulting in a once-printed substrate;
blanketing said once-printed substrate with a nitrogen blanket in said first nitrogen inerting station, resulting in an inerted, once-printed substrate;
applying electromagnetic radiation to said inerted, once-printed substrate in said first curing station, resulting in a cured, once-printed substrate.

4. The method of printing according to claim 3, wherein the step of applying electromagnetic radiation comprises applying ultraviolet radiation from a light emitting diode.

5. The method of printing according to claim 3, further comprising:
generating substantially-pure oxygen and substantially-pure nitrogen using a membrane-based nitrogen generator.

6. The method of printing according to claim 5, further comprising delivering said substantially-pure oxygen to said oxygen inhibition station.

7. The method of printing according to claim 5, further comprising delivering said substantially-pure nitrogen to said nitrogen inerting station.

8. The method of printing according to claim 3, further comprising:
transporting said cured, once-printed substrate through at least one additional series of in-line printing stations comprising at least one additional oxygen inhibition station, at least one additional printing station, at least one additional nitrogen inerting station, and at least one additional curing station;
blanketing said cured, once-printed substrate with at least one additional oxygen blanket in said at least one additional oxygen inhibition station;
applying curable ink to said blanketed, cured, once-printed substrate in said at least one additional printing station, resulting in a twice-printed substrate;
blanketing said twice-printed substrate with at least one additional nitrogen blanket in said at least one additional nitrogen inerting station, resulting in an inerted, twice-printed substrate; and
applying electromagnetic radiation to said inerted, twice-printed substrate in said at least one additional curing station, resulting in a cured, twice-printed substrate.

9. A printing system comprising:
a printer base having a transport belt for advancing a substrate through a printing region;
a rail system coupled to said printer base, said rail system disposed normal to the motion of said substrate, and extending substantially the entire width of said transport belt;
a carriage coupled to said rail system, said carriage comprising a plurality of print heads configured to deposit ultraviolet curable ink onto said substrate, wherein said carriage is configured to traverse forwards and backwards on the rail system while transferring ultraviolet curable ink to said substrate while said substrate advances through the printing region, forming a multipass printing system, the carriage further comprising:
at least one ultraviolet light source positioned such that said at least one ultraviolet light source illuminates and cures an application of ink on a substrate during said carriage's traversal of said rail system;
at least one nitrogen application device configured to emit a blanket of nitrogen gas onto said substrate as said carriage traverses said rail system, wherein said at least one nitrogen application device is positioned such that said blanket of nitrogen gas is applied after the application of ultraviolet curable ink onto said substrate and before said application of ultraviolet curable ink is illuminated with ultraviolet light from said at least one ultraviolet light source;
at least one oxygen application device configured to emit a blanket of oxygen gas onto said substrate as said carriage traverses said rail system, wherein said at least one oxygen application device is positioned such that said blanket of oxygen gas is applied before the application of ultraviolet curable ink onto said substrate.

10. The printing system of claim 9, wherein said carriage further comprises at least one additional ultraviolet light source positioned such that said at least one ultraviolet light source illuminates and cures an application of ink on a substrate during a forwards traversal of said carriage on said rail system and such that said at least one additional ultraviolet light source illuminates and cures an application of ink on a substrate during a backwards traversal of said carriage on said rail system.

11. The printing system of claim 10, wherein said carriage further comprises at least one additional nitrogen application device configured to emit at least one additional blanket of nitrogen gas onto said substrate as said carriage traverses said rail system;
wherein said at least one nitrogen application device is positioned such that said blanket of nitrogen gas is applied after the application of ultraviolet curable ink onto said substrate during said forwards traversal of said carriage on said rail system and before said application of ultraviolet curable ink is illuminated with ultraviolet light from said at least one ultraviolet light source during said forwards traversal of said carriage on said rail system; and
wherein said at least one additional nitrogen application device is positioned such that said at least one additional blanket of nitrogen gas is applied after the application of ultraviolet curable ink onto said substrate during said backwards traversal of said carriage on said rail system and before said application of ultraviolet curable ink is illuminated with ultraviolet light from said at least one additional ultraviolet light source during said backwards traversal of said carriage on said rail system.

12. The printing system of claim 11, wherein said carriage further comprises at least one additional oxygen application device configured to emit at least one additional blanket of oxygen gas onto said substrate as said carriage traverses said rail system;
wherein said at least one oxygen application device is positioned such that said blanket of oxygen gas is applied before a first application of ultraviolet curable ink during a forwards traversal of said carriage on said rail system, thereby protecting said print heads from ultraviolet ink curing onto said plurality of print heads due to stray light in said printing system, and such that said blanket of nitrogen gas from said at least one nitrogen application device supplants said blanket of oxygen, thereby facilitating curing of said ultraviolet curable ink by said at least one ultraviolet light source during said forwards traversal of said carriage on said rail system; and
wherein said at least one additional oxygen application device is positioned such that said at least one additional blanket of oxygen gas is applied before an additional application of ultraviolet curable ink during a backwards traversal of said carriage on said rail system, thereby protecting said print heads from ultraviolet ink curing onto said plurality of print heads due to stray light in said printing system, and such that said at least one additional blanket of nitrogen gas from said at least one additional nitrogen application device supplants said at least one additional blanket of oxygen, thereby facilitating curing of said ultraviolet curable ink by said at least one additional ultraviolet light source during said backwards traversal of said carriage on said rail system.

13. The printing system of claim 12, further comprising a processing unit operatively coupled with said at least one oxygen application device, said at least one additional oxygen application device, said at least one nitrogen application device, and said at least one additional nitrogen application device,
wherein said processing unit is configured for selectively activating and deactivating said at least one oxygen application device, said at least one additional oxygen application device, said at least one nitrogen application device, and said at least one additional nitrogen application device depending on when their use is required.

14. The printing system of claim 9, wherein said plurality of print heads are grouped in a first group of print heads, said system further comprising at least one additional group of print heads separated from said first group of print heads by an intermediary oxygen application device, wherein said intermediary oxygen application device is configured to supply a blanket gas beneath said first group of print heads during a forwards traversal of said carriage on said rail system and to supply a blanket gas beneath said at least one additional group of print heads during a backwards traversal of said carriage on said rail system.

15. The printing system of claim 9, wherein said at least one ultraviolet light source comprises a light emitting diode.

16. The printing system of claim 9, further comprising a membrane-based nitrogen generator configured for:
generating substantially-pure oxygen and substantially-pure nitrogen;
delivering said substantially-pure oxygen to said at least one oxygen application device; and
delivering said substantially-pure nitrogen to said at least one nitrogen application device.

17. A method of printing comprising:
providing a transport belt configured to move a substrate;
providing a printing carriage on a rail system configured normal to the motion of said transport belt, wherein said printer carriage is configured to repeatedly traverse, forwards and backwards, along said rail system, thereby defining a printing region comprising the area beneath said forwards and backwards traversal, and wherein said printer carriage comprises:
at least one group of print heads;
a first ultraviolet light source;
an additional ultraviolet light source;
a first nitrogen application device;
an additional nitrogen application device;
a first oxygen application device; and
an additional oxygen application device;
selectively advancing a substrate through said printing region of a printing system;
emitting a blanket of oxygen gas from said first oxygen application device onto said substrate during a forwards traversal of said carriage on said rail system, thereby creating an oxygen rich environment;
applying an application of ultraviolet curable ink from said at least one group of print heads onto said substrate in said oxygen rich environment;
emitting a blanket of nitrogen gas from said first nitrogen application device onto said substrate after said application of ultraviolet curable ink during said forwards traversal of said carriage on said rail system, thereby supplanting said blanket of oxygen gas and creating a nitrogen rich environment;
exposing said application of ultraviolet curable ink to light in said nitrogen rich environment from said first ultraviolet light source during said forwards traversal of said carriage on said rail system, thereby curing said ultraviolet curable ink;
emitting an additional blanket of oxygen gas from said additional oxygen application device onto said substrate during a backwards traversal of said carriage on said rail system, thereby creating an oxygen rich environment;
applying an application of ultraviolet curable ink from said at least one group of print heads onto said substrate in said oxygen rich environment;
emitting an additional blanket of nitrogen gas from said additional nitrogen application device onto said substrate after said application of ultraviolet curable ink during said backwards traversal of said carriage on said rail system, thereby supplanting said additional blanket of oxygen gas and creating a nitrogen rich environment;
exposing said application of ultraviolet curable ink to light in said nitrogen rich environment from said additional ultraviolet light source during said backwards traversal of said carriage on said rail system, thereby curing said ultraviolet curable ink.

18. The method of claim 17, wherein the said printer carriage further comprises:
at least one additional group of print heads separated from said at least one group of print heads by at least one additional oxygen application device, the method further comprising:
emitting a blanket of oxygen gas from said at least one additional oxygen application device onto said substrate during both of said forwards traversal and backwards traversal of said carriage on said rail system, thereby enhancing said oxygen rich environment.

19. The method of claim 17, further comprising selectively activating and deactivating, by a processor, said first oxygen application device, said additional oxygen application device, said first nitrogen application device, and additional nitrogen application device depending on when their use is required.

20. The method of claim 17, further comprising:
generating substantially-pure oxygen and substantially-pure nitrogen using a membrane-based nitrogen generator operatively coupled with said first nitrogen application device, said additional nitrogen application device, said first oxygen application device, and said additional oxygen application device.
